(19) United States
(12) Patent Application Publication
(10) Pub. No.: US 2016/0077123 A1
(43) Pub. Date: Mar. 17, 2016

(54) STATE DETERMINATION DEVICE AND STORAGE MEDIUM

(71) Applicant: OKI ELECTRIC INDUSTRY CO., LTD., Tokyo (JP)

(72) Inventors: Motoko KAGAYA, Tokyo (JP); Kurato MAENO, Tokyo (JP)

(73) Assignee: OKI ELECTRIC INDUSTRY CO., LTD., Tokyo (JP)

(21) Appl. No.: 14/801,021

(22) Filed: Jul. 16, 2015

(30) Foreign Application Priority Data
Sep. 16, 2014 (JP) 2014-187507

(51) Int. Cl. G01P 13/00; G01P 3/36

(52) U.S. Cl. CPC G01P 13/00; G01P 3/36

(57) ABSTRACT

There is provided a state determination device including: an acquisition unit configured to acquire information indicating a kinetic state of a moving object existing in a target space; a setting unit configured to set a plurality of subspaces in the space; a storage unit configured to store statistical information of kinetic states of the moving object acquired by the acquisition unit from the respective subspaces set by the setting unit; a model estimation unit configured to estimate a kinetic model of the moving object on the basis of the statistical information stored in the storage unit; and a determination unit configured to determine a state of the moving object by comparing the kinetic states of the moving object acquired by the acquisition unit with the kinetic model estimated by the model estimation unit.

### CROSS REFERENCE TO RELATED APPLICATION(S)

This application is based upon and claims benefit of priority from Japanese Patent Application No. 2014-187507, filed on Sep. 16, 2014, the entire contents of which are incorporated herein by reference.

### BACKGROUND

The present invention relates to a state determination device and a storage medium.

Recently, technologies of detecting movements of moving subjects such as a person and a car by using diverse sensors have been developed.

For example, “Transactions of the Japanese Society for Medical and Biological Engineering, vol. 48, No. 6, pp. 595-603 (2010), Detection of Human Motion and Respiration with Microwave Doppler Sensor, Hajime KUBO, Taketoshi MORI, and Tomomasa SATO” (Non-Patent Literature 1) discloses a technology relating to a Doppler sensor capable of measuring movements of a target object without contact. For example, the microwave Doppler sensor radiates a microwave to a target object and measures velocity of the target object with respect to the sensor from Doppler shift of a reflected wave. The Doppler sensor measures distance between the sensor and the target object as phase change of an output signal of the sensor. Accordingly, wide-range distance change from a few millimeters to several meters can be measured.

### SUMMARY

However, although the technology described in Non-Patent Literature 1 can measure the distance change, it is difficult to accurately measure what kind of a state the target object is in. Specifically, when a state is determined on the basis of distance change, a false report may be made or quick reporting may not be achieved. Hereinafter, a state determination method based on distance change is explained on the assumption that an abnormal state such as a fall or night-time wandering is determined by setting a person as a target object. For example, as the state determination method based on distance change, a determination method is considered, by which a state is determined as the abnormal state such as a fall when position of a target object does not change for a predetermined time or more. However, according to the method, there is a possibility of making a false report that a state is determined as the abnormal state, although the state is not the abnormal state actually and a target object rests by sitting down, for example. In addition, according to the method, it is difficult to determine the falling as the abnormal state without predetermined time elapsing even if the fall occurs, and quick reporting may not be achieved.

Accordingly, in a nod to the above described issues, the present invention proposes a novel and improved state determination device and storage medium capable of accurately determining a state of a target object.

According to an embodiment of the present invention, there is provided a state determination device including: an acquisition unit configured to acquire information indicating a kinetic state of a moving object existing in a target space; a setting unit configured to set a plurality of subspaces in the space; a storage unit configured to store statistical information of kinetic states of the moving object acquired by the acquisition unit from the respective subspaces set by the setting unit; a model estimation unit configured to estimate a kinetic model of the moving object on the basis of the statistical information stored in the storage unit; and a determination unit configured to determine a state of the moving object by comparing the kinetic states of the moving object acquired by the acquisition unit with the kinetic model estimated by the model estimation unit.

The model estimation unit may estimate use purpose of the subspaces, and estimate the kinetic model for each integrated space obtained by integrating the subspaces in accordance with each use purpose.

The model estimation unit may estimate the kinetic model for each time slot.

The kinetic model may include staying time indicating time in which the moving object stays in the integrated space.

The kinetic state may include a position and velocity of the moving object. The statistical information may include existence probability and velocity distribution of the moving object in the subspace. The kinetic model may include velocity in the integrated space.

The kinetic state may include a position and a physical activity amount of the moving object. The statistical information may include existence probability and physical activity amount distribution of the moving object in the subspace. The kinetic model may include a physical activity amount in the integrated space.

The determination unit may determine whether the state of the moving object is an abnormal state, on the basis of whether the kinetic state of the moving object acquired by the acquisition unit deviates from the kinetic model.

The state determination device may further include an output unit configured to output a result determined by the determination unit.

The kinetic model may include still time indicating time in which velocity or a physical activity amount of the moving object is continuously less than or equal to a threshold.

The moving object may be a person. The acquisition unit may acquire the information indicating the kinetic state of the moving object from sensing information observed by a sensor that sets a residential space of the moving object as a sensing target.

The sensor may be a sensor configured to transmit a transmission wave and observe a reflected wave reflected by the moving object.

According to another embodiment of the present invention, there is provided a storage medium having a program stored therein, the program causing a computer to function as: an acquisition unit configured to acquire information indicating a kinetic state of a moving object existing in a target space; a setting unit configured to set a plurality of subspaces in the space; a storage unit configured to store statistical information of kinetic states of the moving object acquired by the acquisition unit from the respective subspaces set by the setting unit; a model estimation unit configured to estimate a kinetic model of the moving object on the basis of the statistical information stored in the storage unit; and a determination unit configured to determine a state of the moving object by comparing the kinetic states of the moving object acquired by the acquisition unit with the kinetic model estimated by the model estimation unit.

As described above, according to the embodiments of the present invention, it is possible to accurately determine a state of a target object.

### BRIEF DESCRIPTION OF THE DRAWINGS

FIG. 1 is an explanatory diagram illustrating an overview of a state determination system according to an embodiment of the present invention;

FIG. 2 is a block diagram showing an example of a logical configuration of a state determination device according to the embodiment;

FIG. 3 is an explanatory diagram illustrating a kinetic model according to the embodiment;

FIG. 4 is an explanatory diagram illustrating a kinetic model according to the embodiment;

FIG. 5 is an explanatory diagram illustrating a kinetic model according to the embodiment;

FIG. 6 is a flowchart showing an example of a flow of kinetic model estimation processing executed in the state determination device according to the embodiment; and

FIG. 7 is a flowchart showing an example of a flow of kinetic model estimation processing executed in the state determination device according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. OVERVIEW

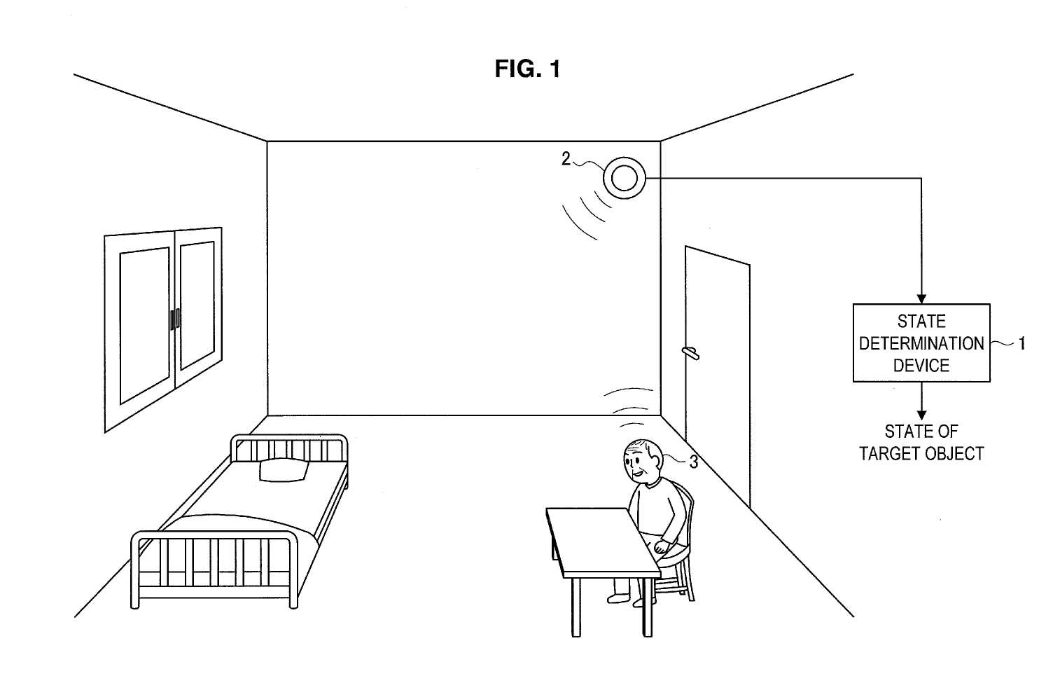

First, with reference to FIG. 1, an overview of a state determination system according to an embodiment of the present invention is explained.

FIG. 1 is an explanatory diagram illustrating an overview of a state determination system according to an embodiment of the present invention. As shown in FIG. 1, the state determination system according to the embodiment includes a state determination device 1 and a sensor 2.

As shown in FIG. 1, for example, the sensor 2 is installed at a corner of a room. The sensor 2 sets, as a sensing target, the whole room in which a moving object 3 that is a target object exists. The sensor 2 may be a so-called Doppler radar, for example. On the basis of sensing information outputted from the sensor 2, the state determination device 1 determines a state of the moving object 3. The state determination device 1 may be a personal computer (PC), for example. In the example shown in FIG. 1, the moving object 3 is a person.

In the room shown in FIG. 1, there are a bed, a chair, a table, and a door, and use purpose of spaces in the room may differ according to locations. For example, the person 3 with a little action may stay for a long time in a living space near the table. In addition, a space from the bed to the door through a rear of the table may be set as a transit space, and the person 3 with large actions may stay for a short time in the transit space. Moreover, in the night, a space on the bed may be used as a sleeping space, and the person 3 with a little action may stay for a long time in the sleeping space.

To such spaces having different use purpose, different criteria for determining abnormal states of the person 3 are preferably set. For example, to stay for a long time with a little action is considered as a normal state in the living space. On the other hand, to stay for a long time with a little action is considered as the abnormal state such as a fall or fainting in the transit space.

Accordingly, the state determination device 1 according to an embodiment of the present invention estimates a kinetic model for each space having different use purpose, and determines a state by using the estimated kinetic model. Thus, the state determination device 1 can accurately determine a state of a person in accordance with a lifestyle of the person and layout of a room.

In addition, such as the example shown in FIG. 1, the technology of constantly sensing a person's daily life and determining abnormal states is strongly requested to protect privacy of the target person. Accordingly, the state determination device 1 estimates use purpose of a space on the basis of sensing information from the sensor 2. For the state determination device 1, prior information such as layout of a room is not necessary. Accordingly, the state determination device 1 can appropriately determine abnormal states while protecting privacy of a person who is a sensing target.

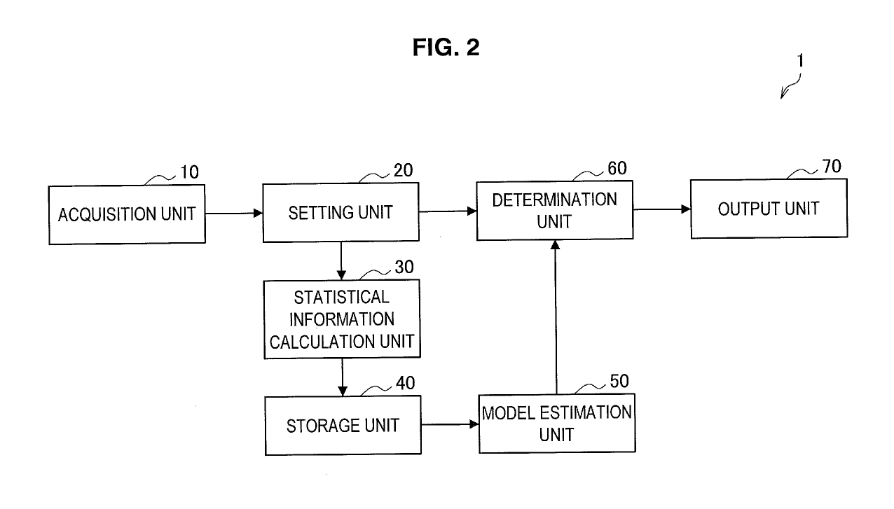

The overview of the state determination system according to the embodiment of the present invention has been explained. Next, with reference to FIGS. 2 to 7, details of the embodiment are explained.

### 2. CONFIGURATION EXAMPLE

### 2-1. Configuration Example of Sensor

The sensor 2 is a sensor configured to transmit a transmission wave and observe a reflected wave reflected by a moving object. The sensor 2 transmits a transmission wave such as a radio wave, ultrasound, an acoustic wave, a microwave, extremely high frequency, or light, and observes the reflected wave reflected by the moving object 3. A plurality of the sensors 2 may be installed. The sensor 2 outputs, as the sensing information, a beat signal obtained by the transmission wave and the reflected wave. In general, it is known that frequency of a reflected wave changes in proportion to velocity of a moving object. The changed frequency difference is frequency of the beat signal. The moving object set as a target for sensing may be a diverse moving object such as a person or a car. Hereinafter, a space set as a sensing target of the sensor 2 is also referred to as a target space.

The configuration example of the sensor 2 according to the embodiment has been explained. Next, with reference to FIG. 2, a configuration example of the state determination device 1 according to the embodiment is explained.

### 2-2. Configuration Example of State Determination Device

FIG. 2 is a block diagram showing an example of a logical configuration of the state determination device 1 according to the embodiment. As shown in FIG. 2, the state determination device 1 includes an acquisition unit 10, a setting unit 20, a statistical information calculation unit 30, a storage unit 40, a model estimation unit 50, a determination unit 60, and an output unit 70.

### (1) Acquisition Unit 10

The acquisition unit 10 has a function of acquiring information (hereinafter, also referred to as kinetic state information) indicating a kinetic state of a moving object existing in a target space. For example, from sensing information of the target space outputted from the sensor 2, the acquisition unit 10 acquires the kinetic state information of the moving object existing in the target space. The kinetic state information may include, for example, information indicating a position and velocity of the moving object.

For example, the acquisition unit 10 calculates the velocity of the moving object on the basis of phase change of the beat signal. In addition, the acquisition unit 10 calculates the position of the moving object by using the beat signal. A method for calculating a position (distance and orientation) of a moving object based on a beat signal is variously considered. For example, the acquisition unit 10 may cause the sensor 2 to alternately transmit transmission waves of slightly different two kinds of frequencies at regular time intervals, and may calculate straight-line distance between the sensor 2 and the moving object on the basis of phase difference of beat signals. On the other hand, the acquisition unit 10 may calculate orientation of the moving object viewed from the sensor 2 by array signal processing. On the other hand, in a case in which the sensor 2 is installed at each of four corners of a room, the acquisition unit 10 may combine measurement results of one-dimensional distance change calculated from beat signals, and may estimate a two-dimensional position. On the other hand, in a case in which a plurality of the sensors 2 is installed at a single place in a manner that the plurality of the sensor 2 has different directions of frequencies of transmission waves and different directions of directivity of reception power characteristics of reflected waves, the acquisition unit 10 may estimate orientation of a moving object on the basis of characteristic of directivity of each of the plurality of the sensors 2, angular difference between directions of directivity of the plurality of the sensors 2, and power of reflected waves received by the plurality of the sensors 2.

In the example shown in FIG. 1, the moving object is a person. In addition, the acquisition unit 10 acquires kinetic state information from sensing information observed by the sensor 2 that sets a person's residential space as a sensing target. As explained above, the present technology may be used for monitoring people such as elderlies, children, or the sick.

The acquisition unit 10 outputs the acquired kinetic state information to the setting unit 20.

### (2) Setting Unit 20

The setting unit 20 has a function of setting a plurality of subspaces in a target space. The subspaces are arbitrarily set. The setting unit 20 may set the subspaces in a manner that the subspaces are adjacent to each other, or in a manner that the subspaces separate from each other. In addition, the setting unit 20 may set the subspaces in a manner that the subspaces have a predetermined shape, or in a manner that the subspaces have different shapes. In addition, the setting unit 20 may set the subspaces in a manner that the subspaces are not overlapped, or in a manner that the subspaces are overlapped. Note that, the setting unit 20 may set the subspaces automatically, or may set the subspaces in response to a user operation. As an example, in the present specification, the setting unit 20 sets mesh-like subspaces in a target space.

Among kinetic state information of the whole target space outputted from the acquisition unit 10, the setting unit 20 extracts kinetic state information acquired from each of the set subspaces. For example, the setting unit 20 refers to a position of a moving object included in the kinetic state information, and determines which subspaces the kinetic state information has been acquired from. Subsequently, the setting unit 20 outputs the extracted kinetic state information of each of the subspaces to the statistical information calculation unit 30 or the determination unit 60.

### (3) Statistical Information Calculation Unit 30

The statistical information calculation unit 30 has a function of calculating statistical information of kinetic states of the moving object acquired by the acquisition unit 10 from the respective subspaces set by the setting unit. For example, the statistical information calculation unit 30 calculates the statistical information for each subspace, from the kinetic state information of each subspace outputted from the setting unit 20. The statistical information may include, for example, existence probability and velocity distribution of the moving object in the subspace.

For example, the statistical information calculation unit 30 calculates existence probability of the moving object in each subspace on the basis of time length in which the moving object stays in each subspace in a predetermined time. In addition, the statistical information calculation unit 30 calculates the velocity distribution by tallying velocity indicated by the kinetic state information in each subspace. Note that, the statistical information calculation unit 30 may use kernel density estimation or the like.

The statistical information calculation unit 30 outputs the calculated statistical information to the storage unit 40.

### (4) Storage Unit 40

The storage unit 40 is a portion that performs recording and reproduction of data with respect to a certain recording medium. For example, the storage unit 40 is implemented as a hard disc drive (HDD). As the recording medium, various kinds of media may naturally be used, including solid-state memory such as flash memory, memory cards incorporating solid-state memory, optical discs, magneto-optical discs, and hologram memory. The recording medium may have a configuration which can execute recording and reproduction in accordance with the recording medium adopted as the storage unit 40.

For example, the storage unit 40 stores the statistical information outputted from the statistical information calculation unit 30. More specifically, the storage unit 40 accumulates statistical information during a period in which a state of the moving object is the normal state.

### (5) Model Estimation Unit 50

The model estimation unit has a function of estimating a kinetic model of the moving object on the basis of the statistical information stored in the storage unit 40. The model estimation unit estimates the kinetic model on the basis of the statistical information of a person's daily life, the statistical information being stored in the storage unit 40. Accordingly, it is not necessary that a fall model is generated by actually causing the person to fall down, for example.

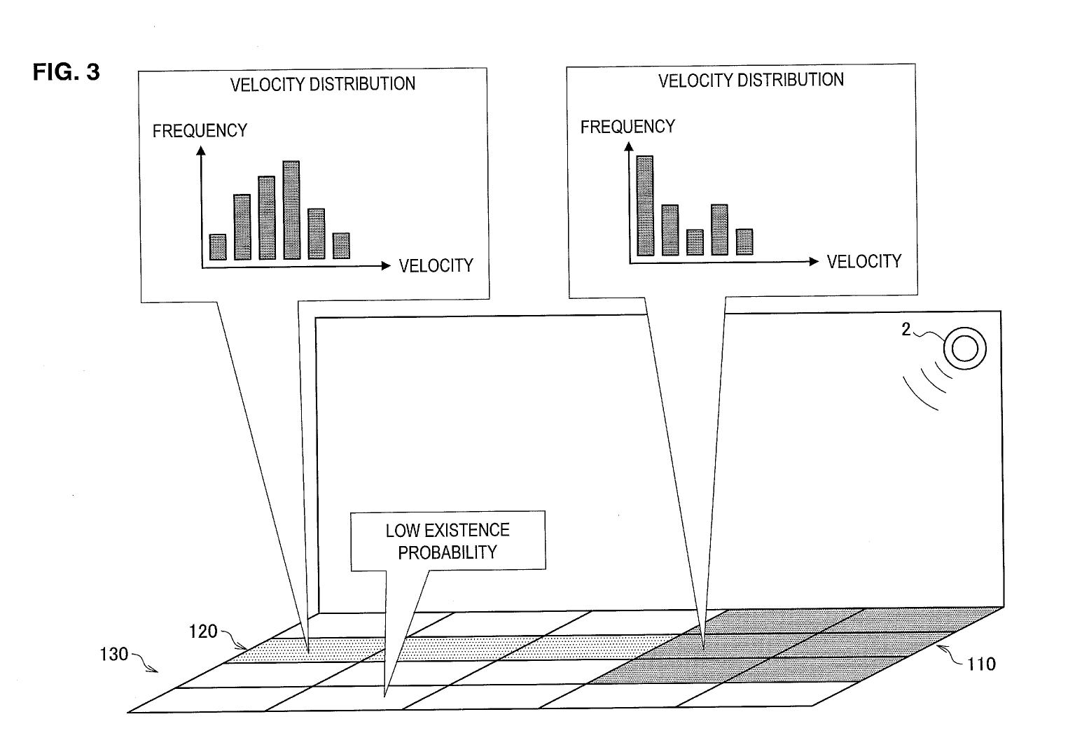

For example, the model estimation unit 50 estimates use purpose of the subspaces, and estimates the kinetic model for each integrated space obtained by integrating the subspaces in accordance with each use purpose. The use purpose of the residential space is considered to include transit purpose (path), living purpose (room), and the like. As a more granular example, the use purpose of the residential space is considered to include eating purpose (table), sleeping purpose (bed) and the like, for example. Hereinafter, with reference to FIG. 3, the estimation of the kinetic model performed by the model estimation unit 50 is explained in detail.

FIG. 3 is an explanatory diagram illustrating a kinetic model according to the embodiment. In an example shown in FIG. 3, the target space set as the sensing target of the sensor 2 is divided into mesh-like subspaces. As shown in FIG. 3, According to statistical information of subspaces in an area indicated by a reference sign 110, velocity distribution is biased toward low velocity. Thus, the model estimation unit 50 estimates that the use purpose of the subspaces in the area indicated by the reference sign 110 is living purpose. Subsequently, the model estimation unit 50 estimates a kinetic model for living purpose in a living space obtained by integrating the subspaces for living purpose indicated by the reference sign 110. Meanwhile, according to statistical information of subspaces in an area indicated by a reference sign 120, velocity distribution is biased toward high velocity. Thus, the model estimation unit 50 estimates that the use purpose of the subspaces in the area indicated by the reference sign 120 is transit purpose. Subsequently, the model estimation unit 50 estimates a kinetic model for transit purpose in a transit space obtained by integrating the subspaces for transit purpose indicated by the reference sign 120. Meanwhile, according to statistical information of subspaces in an area indicated by a reference sign 130, existence probability is low. Thus, the model estimation unit 50 estimates that the subspaces in the area indicated by the reference sign 130 are not used (person does not enter the subspaces). Subsequently, the model estimation unit 50 estimates a kinetic model for a disused space obtained by integrating the disused subspaces indicated by the reference sign 130.

By estimating a kinetic model for each integrated space having different use purpose, the model estimation unit 50 can estimate a more accurate kinetic model compared with a case of estimating a single kinetic model for the whole target space. Accordingly, state determination accuracy of the state determination device 1 is improved. Note that, the model estimation unit 50 may perform estimation on the assumption that adjacent or near subspaces have a high probability of having same use purpose. In this case, it is possible for the model estimation unit 50 to avoid unnatural estimation like transit spaces and living spaces alternately appear, for example. In addition, the model estimation unit 50 can integrate subspaces as a group of spaces according to use purpose.

The kinetic model estimated by the model estimation unit 50 is variously considered. For example, the kinetic model may include staying time indicating time in which the moving object stays in the integrated space. For example, the model estimation unit 50 estimates, for the transit space, a kinetic model in which a short staying time is set. On the other hand, the model estimation unit 50 estimates, for the living space, a kinetic model in which a long staying time is set. Accordingly, the state determination device 1 can determine long time stay as the abnormal state such as a fall or fainting, in a case of detecting the long time stay of a person in a space to which a short staying time is set such as a corridor. Note that, the kinetic model may include velocity in the integrated space. For example, the model estimation unit 50 estimates, for the transit space, a kinetic model in which high velocity is set. On the other hand the model estimation unit 50 estimates, for the living space, a kinetic model in which a low velocity is set. Accordingly, the state determination device 1 can determine a low transit velocity of a person as the abnormal situation such as injury or paralysis, in a case of detecting the low transit velocity of the person in a space to which a high velocity is set such as a corridor.

As another example, the kinetic model may include a physical activity amount (METs: Metabolic Equivalents) in the integrated space. Accordingly, the state determination device 1 can determine a small physical activity amount of a person as the abnormal state such as a fall or fainting, in a case of detecting the small physical activity amount of the person in a space to which a large physical activity amount due to transit or the like is set such as a corridor. Note that, in a case in which the physical activity amount is adopted for the kinetic model, the kinetic state information may include information indicating a position and the physical activity amount of the moving object, and the statistical information may include existence probability and physical activity amount distribution of the moving object in the subspace. Note that, examples of the sensor configured to observe sensing information on the physical activity amount include, for example, a gyro sensor, an acceleration sensor, and a heart rate monitor that are mounted on the moving object.

The kinetic model may include still time indicating time in which velocity or a physical activity amount of the moving object is continuously less than or equal to a threshold. Accordingly, in a case of detecting that a person is still for too long a time, the state determination device 1 can determine the case as an abnormal situation in which it is highly necessary to stop sitting.

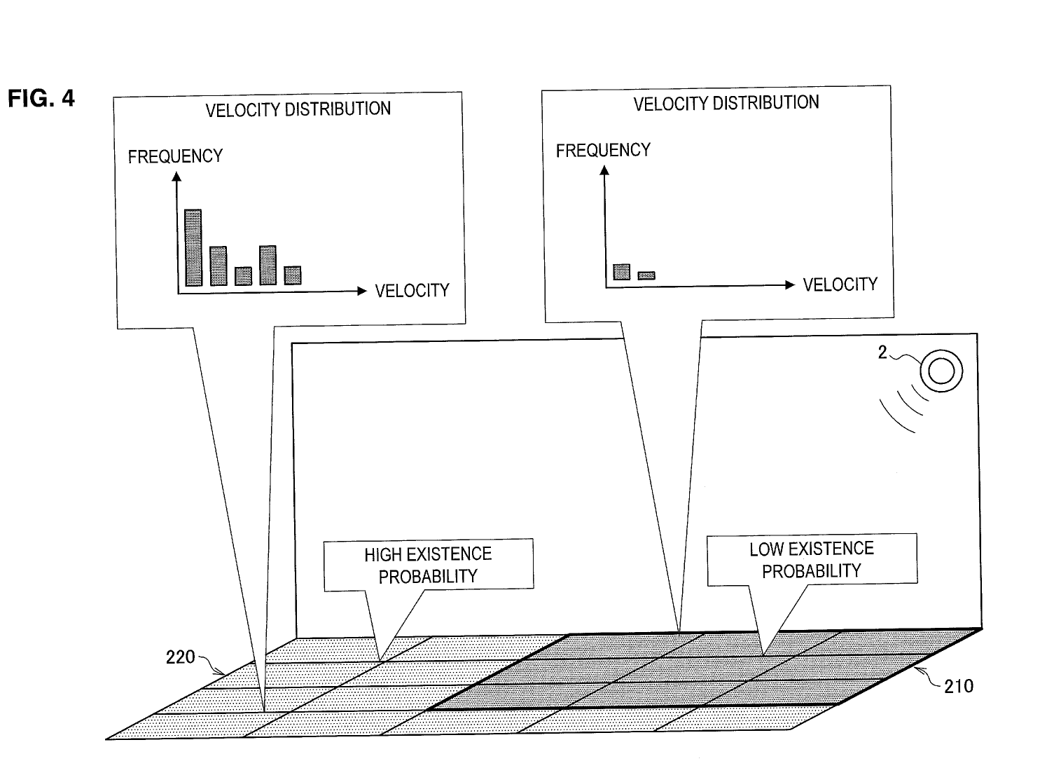

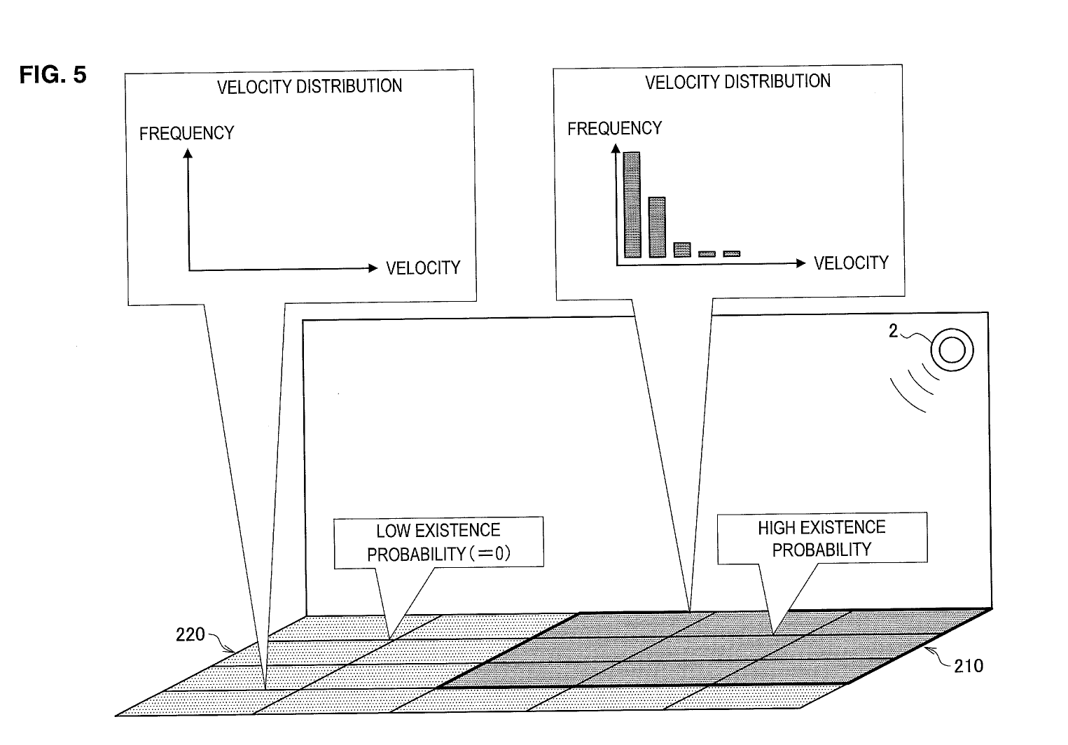

The model estimation unit 50 may estimate the kinetic model for each time slot. The model estimation unit 50 estimates a kinetic model for each time slot in accordance with the statistical information for each time slot stored in the storage unit 40. For example, the model estimation unit 50 can estimate a kinetic model at any granularity such as every one hour, every day and night, every day, every week, or every season. Hereinafter, with reference to FIGS. 4 and 5, the estimation of the kinetic model performed by the model estimation unit 50 for each time slot is explained in detail.

FIGS. 4 and 5 are each an explanatory diagram illustrating a kinetic model according to the embodiment. An example in FIG. 4 shows an estimation example of a daytime kinetic model, and an example in FIG. 5 shows an estimation example of a night-time kinetic model. As shown in FIG. 4, according to daytime statistical information of subspaces in an area indicated by a reference sign 210, velocity distribution is biased toward low velocity, frequency is low, and existence probability is low. As shown in FIG. 5, according to night-time statistical information of the subspaces in the area indicated by the reference sign 210, velocity distribution is biased toward low velocity, frequency is high, and existence probability is high. Thus, the model estimation unit 50 estimates that the use purpose of the subspaces in the area indicated by the reference sign 210 is sleeping purpose (bed). Subsequently, the model estimation unit 50 estimates a kinetic model for night-time sleeping purpose with respect to the sleeping space obtained by integrating the subspaces for sleeping purpose indicated by the reference sign 210. On the other hand, as shown in FIG. 4, according to daytime statistical information of subspaces in an area indicated by a reference sign 220, velocity distribution is biased toward low velocity, and existence probability is high. As shown in FIG. 5, according to night-time statistical information of the subspaces in the area indicated by the reference sign 220, there is no velocity distribution, and existence probability is low (zero). Thus, the model estimation unit 50 estimates that the use purpose of the subspaces in the area indicated by the reference sign 220 is activity purpose (living purpose other than the bed). Subsequently, the model estimation unit 50 estimates a kinetic model for daytime activity purpose with respect to an activity space obtained by integrating the subspaces for activity purpose indicated by the reference sign 220.

By estimating a kinetic model for each time slot, the model estimation unit 50 can estimate a more accurate kinetic model compared with a case of estimating a single kinetic model. Accordingly, the state determination device 1 can determine states more sensitively. For example, in a case in which a demented person wanders, the state determination device 1 can determine the case as the abnormal state when detecting a moving object moving at high velocity during night-time in a place other than the sleeping space. Alternatively, in a case in which a person falls out of a bed, the state determination device 1 can determine the case as the abnormal state when detecting a moving object moving at low velocity or hardly moving during night-time in a place other than the sleeping space.

The model estimation unit 50 outputs the estimated kinetic model to the determination unit 60.

### (6) Determination Unit 60

The determination unit 60 has a function of determining a state of the moving object by comparing the kinetic states of the moving object acquired by the acquisition unit 10 with the kinetic model estimated by the model estimation unit 50. Specifically, the determination unit 60 determines whether the state of the moving object is the abnormal state, on the basis of whether the kinetic state of the moving object acquired by the acquisition unit 10 deviates from the kinetic model. For example, the determination unit 60 temporarily accumulates the velocity and the position of the moving object that have been acquired by the acquisition unit 10, and calculates staying time and average velocity in each integrated space. Subsequently, the determination unit 60 compares a calculated result with staying time and velocity that are indicated by the kinetic model in the integrated space corresponding to the position of the moving object. In a case in which deviation degree exceeds a threshold, the determination unit 60 determines the case as the abnormal state. In a case in which the deviation degree is less than or equal to the threshold, the determination unit 60 determines the case as the normal state.

### (7) Output Unit 70

The output unit 70 has a function of outputting a result determined by the determination unit 60. For example, the output unit 70 may be implemented as a display device, a sound output device, or a communication device configured to perform notification to a remote location by using an e-mail or the like. The output unit 70 may outputs the determination result to an administrator of the state determination device 1, a hospital, a family member of a monitored person, and the like. The output unit 70 may outputs, to the monitored person, a notification encouraging the monitored person to stop sitting, for example.

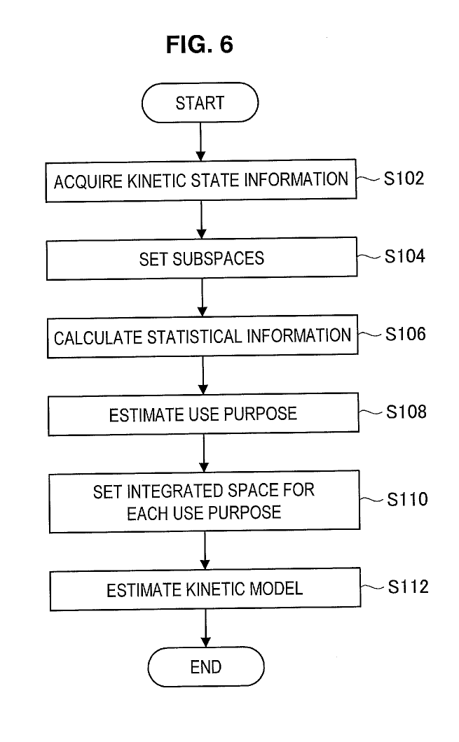

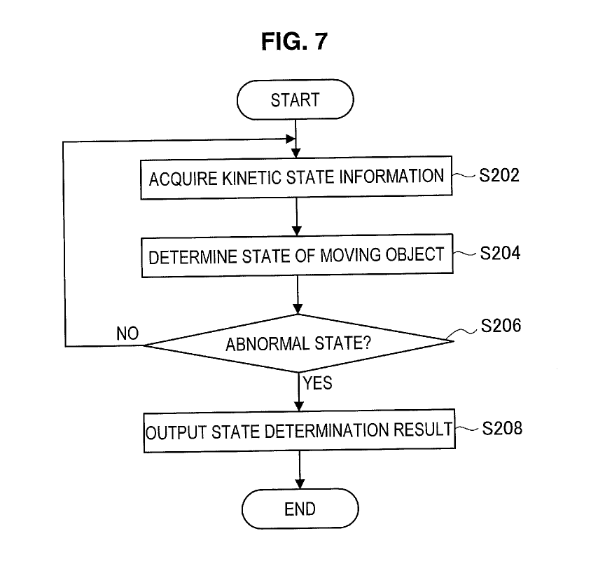

The configuration example of the state determination device 1 according to the embodiment has been explained. Next, with reference to FIGS. 6 and 7, an operation processing example of the state determination system 1 according to the embodiment is explained.

### 3. OPERATION PROCESSING EXAMPLE

### 3-1. Kinetic Model Estimation Processing

FIG. 6 is a flowchart showing an example of a flow of kinetic model estimation processing executed in the state determination device 1 according to the embodiment.

As shown in FIG. 6, in Step S102, the acquisition unit 10 first acquires kinetic state information indicating a kinetic state of a moving object existing in a target space. For example, as the kinetic state information, the acquisition unit 10 acquires information indicating a position and velocity of the moving object existing in the target space, from sensing information of the target space outputted from the sensor 2.

Next, in Step S104, the setting unit 20 sets subspaces. For example, the setting unit 20 sets mesh-like subspaces in the target space.

Next, in Step S106, the statistical information calculation unit 30 calculates statistical information. For example, from the kinetic state information acquired by the acquisition unit 10 in the subspaces set by the setting unit 20, the statistical information calculation unit 30 calculates the statistical information including existence probability and velocity distribution of the moving object for each subspace. The calculated statistical information is stored in the storage unit 40.

Next, in Step S108, the model estimation unit 50 estimates use purpose of the subspaces. For example, the model estimation unit 50 estimates that use purpose of a subspace in which velocity distribution is biased toward low velocity and existence probability is high is living purpose. Meanwhile, the model estimation unit 50 estimates that use purpose of a subspace in which velocity distribution is biased toward high velocity and existence probability is low is transit purpose.

Next, in Step S110, the model estimation unit 50 sets an integrated space for each use purpose. For example, the model estimation unit 50 links and integrates subspaces for each use purpose. For example, the model estimation unit 50 integrates subspaces for living purpose and sets a living space (room). In addition, the model estimation unit 50 integrates subspaces for transit purpose and sets transit space (corridor).

Next, in Step S112, the model estimation unit 50 estimates a kinetic model. For example, the model estimation unit 50 estimates, for the transit space, a kinetic model in which a short staying time and high velocity are set. On the other hand, the model estimation unit 50 estimates, for the living space, a kinetic model in which a long staying time and low velocity are set.

The example of the kinetic model estimation processing according to the embodiment has been explained. Next, with reference to FIG. 7, an example of state determination processing according to the embodiment is explained.

### 3-2. State Determination Processing

FIG. 7 is a flowchart showing an example of a flow of state determination processing executed in the state determination device 1 according to the embodiment.

As shown in FIG. 7, in Step S202, the acquisition unit 10 first acquires kinetic state information indicating a kinetic state of a moving object existing in a target space.

Next, in Step S204, the determination unit 60 determines a state of a moving object. For example, the determination unit 60 determines whether the state of the moving object is the abnormal state, on the basis of whether the kinetic state of the moving object acquired by the acquisition unit 10 deviates from the kinetic model estimated in the kinetic model estimation processing.

In a case in which it is determined that the state of the moving object is the normal state (NO in Step S206), the processing returns to Step S202.

On the other hand, in a case in which it is determined that the state of the moving object is the abnormal state (YES in Step S206), the output unit 70 outputs a state determination result in Step S208. For example, the output unit 70 notifies an administrator or the like of the abnormal state.

The example of the state determination processing according to the embodiment has been explained.

### 4. CONCLUSION

With reference to FIGS. 1 to 7, details of the embodiment of the present invention have been explained. As explained above, the state determination device 1 sets a plurality of subspaces set as a target space, and stores statistical information of kinetic states of the moving object acquired in the respective subspaces. Subsequently, the state determination device 1 estimates kinetic models from the stored statistical information, and determines a state of the moving object by using the estimated kinetic models. The state determination device 1 can accurately determine the state of the target object since the state determination device 1 estimates the kinetic models from the statistical information of the respective subspaces. For example, in the case in which the target object is a person, the state determination device 1 can appropriately determine a state in accordance with layout of a residential space of the person.

In addition, the state determination device 1 estimates use purpose of the subspaces, and estimates the kinetic model for each integrated space obtained by integrating the subspaces in accordance with each use purpose. Accordingly, the state determination device 1 can estimate the kinetic model for each space used for a variety of use purpose, for example, transit purpose, living purpose, eating purpose, and sleeping purpose. A person moves in a different way in a space having different use purpose. Thus, the state determination device 1 uses kinetic models according to use purpose, and determines a state of the person more accurately.

For example, in a case in which a person stays in a place having low existence probability such as a transit space, the state determination device 1 determines the case as abnormal. In a case in which the person stays in a living space or the like, the state determination device 1 determines the case as normal. As described above, the state determination device 1 can avoid false state determination, and can reduce false reports. Meanwhile, in a case of detecting a still person transiting at low velocity or hardly moving in a space such as the transit space in which a person moves at high velocity, the state determination device 1 can determines the case as abnormal like a fall. As described above, the state determination device 1 can detect the abnormal state in a short time in accordance with use purpose of a space, and can achieve quick reporting.

In addition, since the state determination device 1 estimates e kinetic model on the basis of statistical information, prior information such as layout of a room is not necessary. Accordingly, the state determination device 1 can protect privacy of a person who is a determination target, when the state determination device 1 is used for monitoring purpose.

In addition, the state determination device 1 may estimate the kinetic model for each time slot. Accordingly, the state determination device 1 can determine states more sensitively. For example, in the case in which the target object is a person, the state determination device 1 can appropriately determine a state in accordance with a lifestyle of the person.

In addition, the state determination device 1 determines a state by using sensing information from a sensor configured to transmit a transmission wave and observe a reflected wave reflected by the moving object. Accordingly, the state determination device 1 can protect privacy of a person who is a determination target, in comparison with a technology of determining a state by using an imaging device or a gesture recognition device such as Kinect (registered trademark). In view of the continuous sensing in the residential space, it is considered that the device used for monitoring a person is strongly requested to protect privacy. Meanwhile, the sensor using transmission waves and reception waves can perform sensing in a target space even if there is a shielding. Accordingly, the state determination device 1 is appropriate for use in the residential space in which an obstacle may exist, in comparison with the technology of determining a state by using an imaging device and a gesture recognition device such as Kinect.

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

For example, in the embodiment, the example in which the state determination device 1 is used for monitoring a person has been explained. However, the present invention is not limited thereto. For example, the state determination device 1 may be used for security purpose to prevent intrusion or the like. For example, in a passageway of an apartment building through which people walk quickly, the state determination device 1 may determines a moving object as a thief who are trying to illegally unlock a door, the moving object transiting at a low transit velocity and who stays for a long time in a space in front of the door.

The state determination device 1 explained in the present specification may be configured as a single device. Alternatively, a part of or the entirety of the state determination device 1 may be configured as separate devices. For example, in the functional configuration example of the state determination device 1 shown in FIG. 2, the acquisition unit 10, the setting unit 20, the statistical information calculation unit 30, the storage unit 40, the model estimation unit 50, and the determination unit 60 may be provided in a device such as a server connected to the sensor 2 and output unit 70 via a network or the like. In the case in which the acquisition unit 10, the setting unit 20, the statistical information calculation unit 30, the storage unit 40, the model estimation unit 50, and the determination unit 60 are provided in the device such as the server, information is transmitted from the sensor 2 to the device such as the server via the network or the like, a result determined by the determination unit 60 is returned, and the output unit 70 outputs the result.

A series of processing to be performed by each device described in the present specification may be implemented using either software or hardware, or a combination of software and hardware. Programs constituting software may be previously stored, for example, in a storage medium (non-transitory media) provided inside or outside each device. Each of the programs is then loaded into RAM at run time and executed by a processor such as a CPU.

It may not be necessary to execute the processing described using the sequence diagrams or the flowcharts in the present specification in the illustrated order. Some of the processing steps may be processed in parallel. In addition, an additional processing step may be added, and some processing steps may be omitted.

What is claimed is:

1. A state determination device comprising:
an acquisition unit configured to acquire information indicating a kinetic state of a moving object existing in a target space;
a setting unit configured to set a plurality of subspaces in the space;
a storage unit configured to store statistical information of kinetic states of the moving object acquired by the acquisition unit from the respective subspaces set by the setting unit;
a model estimation unit configured to estimate a kinetic model of the moving object on the basis of the statistical information stored in the storage unit; and
a determination unit configured to determine a state of the moving object by comparing the kinetic states of the moving object acquired by the acquisition unit with the kinetic model estimated by the model estimation unit.

2. The state determination device according to claim 1,
wherein the model estimation unit estimates use purpose of the subspaces, and estimates the kinetic model for each integrated space obtained by integrating the subspaces in accordance with each use purpose.

3. The state determination device according to claim 2,
wherein the model estimation unit estimates the kinetic model for each time slot.

4. The state determination device according to claim 2,
wherein the kinetic model includes staying time indicating time in which the moving object stays in the integrated space.

5. The state determination device according to claim 2,
wherein the kinetic state includes a position and velocity of the moving object,
wherein the statistical information includes existence probability and velocity distribution of the moving object in the subspace, and
wherein the kinetic model includes velocity in the integrated space.

6. The state determination device according to claim 2,
wherein the kinetic state includes a position and a physical activity amount of the moving object,
wherein the statistical information includes existence probability and physical activity amount distribution of the moving object in the subspace, and
wherein the kinetic model includes a physical activity amount in the integrated space.

7. The state determination device according to claim 1,
wherein the determination unit determines whether the state of the moving object is an abnormal state, on the basis of whether the kinetic state of the moving object acquired by the acquisition unit deviates from the kinetic model.

8. The state determination device according to claim 1, further comprising:
an output unit configured to output a result determined by the determination unit.

9. The state determination device according to claim 1,
wherein the kinetic model includes still time indicating time in which velocity or a physical activity amount of the moving object is continuously less than or equal to a threshold.

10. The state determination device according to claim 1,
wherein the moving object is a person, and
wherein the acquisition unit acquires the information indicating the kinetic state of the moving object from sensing information observed by a sensor that sets a residential space of the moving object as a sensing target.

11. The state determination device according to claim 10,
wherein the sensor is a sensor configured to transmit a transmission wave and observe a reflected wave reflected by the moving object.

12. A storage medium having a program stored therein, the program causing a computer to function as:
an acquisition unit configured to acquire information indicating a kinetic state of a moving object existing in a target space;
a setting unit configured to set a plurality of subspaces in the space;
a storage unit configured to store statistical information of kinetic states of the moving object acquired by the acquisition unit from the respective subspaces set by the setting unit;
a model estimation unit configured to estimate a kinetic model of the moving object on the basis of the statistical information stored in the storage unit; and
a determination unit configured to determine a state of the moving object by comparing the kinetic states of the moving object acquired by the acquisition unit with the kinetic model estimated by the model estimation unit.
